(19) United States
(12) Patent Application Publication
(10) Pub. No.: US 2023/0237569 A1
(43) Pub. Date: Jul. 27, 2023

(54) PREDICTION METHOD BASED ON MERCHANT TRANSACTION DATA

(71) Applicant: STRIPE, INC., South San Francisco, CA (US)

(72) Inventors: Jun WEN, South San Francisco, CA (US); Bo XU, South San Francisco, CA (US); Bryan IRACE, South San Francisco, CA (US); Jack DENT, South San Francisco, CA (US); Sharif CORINALDI, South San Francisco, CA (US); Yaakov ERLICHMAN, South San Francisco, CA (US)

(21) Appl. No.: 17/573,530

(22) Filed: Jan. 11, 2022

(51) Int. Cl. G06Q 40/02; G06Q 10/04

(52) U.S. Cl. CPC G06Q 40/025; G06Q 10/04

(57) ABSTRACT

Methods and apparatuses for performing prediction based on merchant transaction data are described. In some embodiments, a method comprises: receiving, by one or more payment processing systems, from a plurality of merchant computing devices associated with a plurality of merchants, respectively, transaction data of transactions performed between the plurality of merchants and a plurality of customers; applying, by the one or more payment processing systems, an interpretable machine learning model framework to produce predictions based at least on the transaction data; determining whether to provide loan financing to merchants based on the predictions; and providing, by the payment processing system, loan financing to an account of at least one merchant in response to the determination, including configuring repayment terms individually for each of the merchants receiving the loan financing.

### FIELD OF THE INVENTION

Embodiments of the present invention relate to the field of systems for processing commercial transactions; more particularly, embodiments of the present invention relate to use of a machine learning (ML) framework to process data related to commercial transactions.

### BACKGROUND

Today, many merchants use third parties to handle all their payment processing needs for commercial transactions. In some cases, the merchants redirect their customers to the third party, who is responsible for capturing the payment information and processing the transaction, or the merchants capture payment information themselves from their customers and send it to a third-party payment gateway for real-time authorization of transactions and subsequent settlement of funds.

Cash advances are often provided by credit card issuers or issuers of charge cards. As part of a cash advance, cardholders are allowed to withdraw cash up to a certain limit. For a credit card, the cash advances are limited based on the credit limit of the card or to some percentage of the card’s credit limit. There is usually a cost to take a cash advance that is a percentage of the amount that is being advanced. A problem with the typical cash advances made with credit cards is that the interest higher than other credit card transactions and typically compounds daily from the day the cash is borrowed, even if no cash is available to be paid back. However, while cash advances are available from issuers of credit and charge cards, such advances are typically not available through third party gateways performing payment processing, even when the payment processing involves credit and charge cards.

One problem associated with providing cash advances and other types of financing products (e.g., loans (e.g., flex loans, etc.)) to an obligor (e.g., a merchant) is determining upon what to base the financing product. If the financing products are based on future revenues and/or cash flows, a reliable prediction method must be available to ensure that decisions to offer cash advances and other such financing products are made prudently. As such financing products are often regulated, any such prediction method must also comply with existing regulatory schemes.

### SUMMARY

Methods and apparatuses for performing prediction based on merchant transaction data are described. In some embodiments, a method comprises: receiving, by one or more payment processing systems, from a plurality of merchant computing devices associated with a plurality of merchants, respectively, transaction data of transactions performed between the plurality of merchants and a plurality of customers; applying, by the one or more payment processing systems, an interpretable machine learning model framework to produce predictions based at least on the transaction data; determining whether to provide loan financing to merchants based on the predictions; and providing, by the payment processing system, loan financing to an account of at least one merchant in response to the determination, including configuring repayment terms individually for each of the merchants receiving the loan financing.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 shows a flow diagram of the steps and entities for implementing payment processing.

FIG. 2 is a bock diagram of a networked arrangement for a machine learning (ML) framework to access on-line and off-line storage of data.

FIG. 3 is a block diagram of one embodiment of an ML framework.

FIG. 4 illustrates one embodiment of a process flow for implementing loan financing process using the ML framework.

FIG. 5 illustrates one embodiment of a process flow for implementing an advance on future payments.

FIG. 6 illustrates an example of a process for handling the advances described herein in conjunction with a payment processing flow.

FIG. 7 is a more detailed flow diagram of one embodiment of a process for performing an advance that is paid down when processing transactions with a payment processing system.

FIG. 8 illustrates one embodiment of a process flow for implementing a regulatory or compliance process using an ML framework.

FIG. 9 is a block diagram of one embodiment of a payment processing system.

FIG. 10 is a block diagram of one embodiment of a computer system.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, to avoid obscuring the present invention.

Techniques are disclosed herein for making predictions regarding merchant transaction data are disclosed. In one embodiment, the predictions are regarding a merchant’s future processing volume in a commerce platform. In one embodiment, the predictions are regarding decreases and/or increases in a merchant’s future processing volume, which may be indicative of future revenue of the merchant. In one embodiment, the future processing volume is associated with handling transactions involving payment flows in a payment processing infrastructure.

In one embodiment, the predictions are made using a machine learning (ML) framework described herein. The machine learning framework is utilized to create models for prediction and analytics based on data that is collected and obtained. In one embodiment, the data corresponds to one or more of transaction data related to payment processing information, other data internal to a payment processing system, and one or more external signals. That is, the payment processing information includes transaction data corresponding to transactions for which payment processing is performed. In one embodiment, the ML framework uses an interpretable machine learning model to make the predictions. More detail regarding the interpretable machine learning model is provided below.

In one embodiment, the predictions are used to determine whether to provide loan financing to one or more merchants. The loan financing may be related to a cash advance or other type of loan that is provided by a payment processing infrastructure. That is, the techniques disclosed herein enable a payment processing infrastructure to incorporate the processing of advances to merchants and other service providers and their associated paydowns while handling the settlement process. In one embodiment, the cash advances are in the form of flex loans that have minimum payments. In one embodiment, the minimum payments are calculated according to the cash advance amount.

A description is provided below of an example of a payment processing environment in which techniques described herein may be employed, including a definitions associated with the same, followed by a more in-depth description of the ML-based framework for providing financing products to parties in the payment processing environment. The techniques described herein are not limited to use in this payment processing environment and may be used in other commerce platforms. Certain terminology is used herein for convenience only and is not to be taken as a limitation on the present invention. Embodiments of the present invention is described in the context of an online payment acceptance service called Stripe® commercialized by Stripe, Inc., San Francisco, California.

The following definitions are provided to promote understanding of the techniques described herein.

Card Network (or Card Association) - refers to financial payment networks such as Visa®, MasterCard®, American Express®, Diners Club®, JCB® and China UnionPay®.

Processor - A processor is a company (often a third party) appointed to handle credit card transactions. They have connections to various card networks and supply authorization and settlement services to merchants or payment service providers. They can also move the money from the issuing bank to the merchant or acquiring bank.

Acquiring Bank - An acquiring bank (or acquirer) is the bank or financial institution that accepts credit and or debit card payments from affiliated card networks for products or services on behalf of a merchant or payment service provider.

Card Issuing Bank - A card issuing bank is a bank that offers card network or association branded payment cards directly to consumers. The issuing bank assumes primary liability for the consumer’s capacity to pay off debts they incur with their card.

Payment Information - In one embodiment for making payment via a credit card or debit card, the payment information includes primary account number (PAN) or credit card number, card validation code, expiration month and year. In another embodiment for making payment via an Automated Clearinghouse (ACH) transaction, the payment information includes a bank routing number and an account number within that bank. The payment information includes at least some sensitive, non-public information.

Merchant - A merchant, as used herein, is an entity that is associated with selling or licensing products and/or services over electronic systems such as the Internet and other computer networks. The merchant may be the direct seller/licensor, or the merchant may be an agent for a direct seller/licensor. For example, entities such as Amazon® sometimes act as the direct seller/licensor, and sometimes act as an agent for a direct seller/licensor.

Merchant Site - The merchant site is the e-commerce site (e.g., website) of the merchant. The merchant (100) and merchant server (120) in the figures are associated with the merchant site. The merchant site is associated with a client-side (client side) application and a server-side (server side) application. In one embodiment, the merchant site includes Merchant Server (120), and the server-side application executes on the Merchant Server (120).

Customer’s Electronic Device - This is the device that the customer uses to interact with the merchant. Examples of this device include a desktop computer, a laptop computer, a mobile device (e.g., smartphone, tablet) and game console. The customer’s electronic device may interact with the merchant via a browser application that executes on the device, or via a native application (app) installed onto the customer’s device. The client-side application executes on the customer’s electronic device.

Payment Processor - A payment processor, as referred to herein, is an entity or a plurality of entities that facilitate a transaction between a merchant site and a customer’s electronic device. The payment processor includes selected functionality of both Stripe (300) and Processor (400)/Card Networks (500). For example, in one embodiment, Stripe (300) creates tokens and maintains and verifies publishable (non-secret) keys and secret keys in a manner well-known in the art. See for example, U.S. Pat. Nos. 10,134,036, 9,830,596, and 9,824,354. The Processor (400)/Card Networks (500) is involved in authorizing or validating payment information. In one embodiment, Stripe (300) and the Processor (400)/Card Networks (500) function together to authorize and validate payment information, issue a token, and settle any charges that are made. Accordingly, in one embodiment, the payment processor refers to the functionality of Stripe (300) and the functionality of the Processor (400)/Card Networks (500). In another preferred embodiment wherein step 3A in the high-level description is not performed, and Stripe (300) performs its own verification before issuing a token, the Processor (400)/Card Networks (500) are still used for settling any charges that are made, as described in step 7A in the high-level description. Accordingly, in this embodiment, the payment processor may refer only to the functionality of Stripe (300) with respect to issuing tokens.

Native Application - A Native Application or “native app” is an application commonly used with a mobile device, such as a smartphone or tablet. When used with a mobile device, the native app is installed directly onto the mobile device. Mobile device users typically obtain these apps through an online store or marketplace, such as an app store (e.g., Apple’s App Store, Google Play store). More generically, a native application is designed to run in the computer environment (machine language and operating system) that it is being run in. It can be referred to as a locally installed application. A native application differs from an interpreted application, such as a Java applet, which requires interpreter software. A native application also differs from an emulated application that is written for a different platform and converted in real-time to run, and also differs from a Web application that is run within the browser.

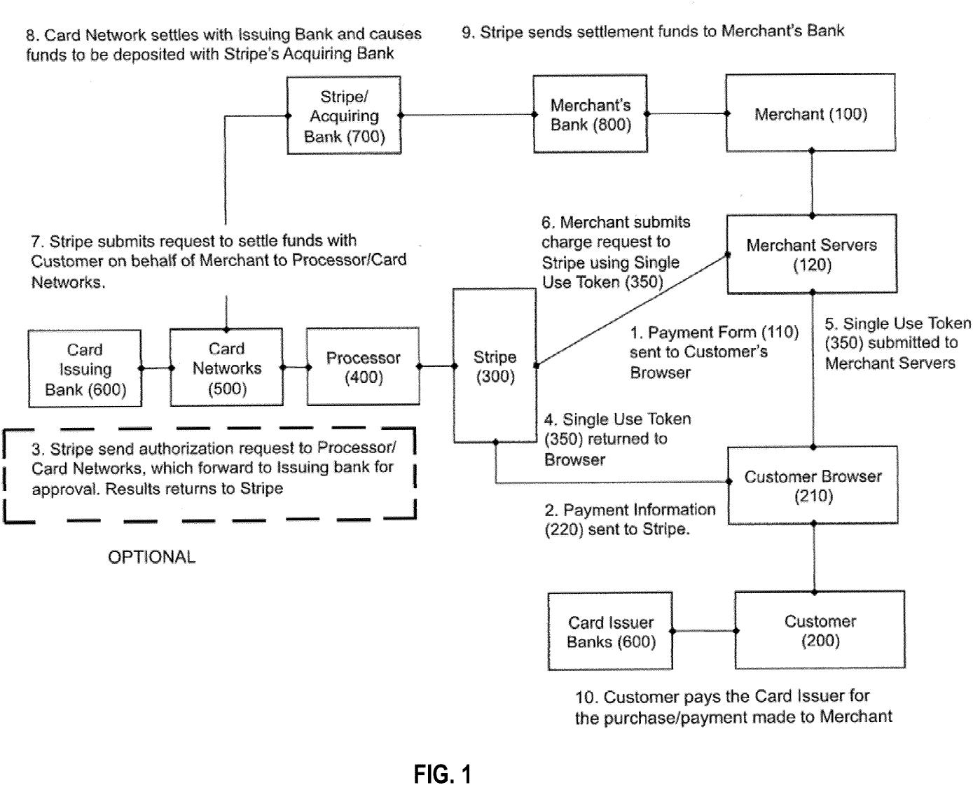

FIG. 1 shows a flow diagram of the steps and entities for implementing payment processing flow embodiments of the present invention.

At a high level, the payment processing framework described herein works as follows (FIG. 1):

1. A Merchant’s Customer (200) uses an internet-enabled browser (210) to visit the Merchant’s site. In one embodiment, Customer (200) is served a Stripe.js enabled Payment Form (110) using standard web technologies. Stripe.js is well-known in the art. For more information on Stripe.js, see U.S. Pat. Nos. 10,134,036, 9,830,596, and 9,824,354. The Customer (200) enters the necessary information including their Payment Information (220) and submits the Payment Form (110). The Billing Info portion of the Payment Form (110) is for payment via a credit card or debit card. If payment is to be made via an Automated Clearinghouse (ACH) transaction, the Billing Info portion of the Payment Form (110) will request a bank routing number and an account number within that bank, and possibly additional information, such as the bank name and whether the account is a checking or savings account.

2. The Customer’s payment information (220) is sent from the Customer’s browser (210) to Stripe (300), never touching the Merchant’s Servers (120). In this manner, the client-side application electronically sends payment information retrieved from the customer’s electronic device to the payment processor. The client-side application does not send the payment information (220) to the server-side application.

3. In one embodiment, Stripe (300) submits the relevant transaction to a Processor (400) or directly to the Card Network (500) for authorization or validation of the payment information. The Card Network (500) sends the request to the Card Issuing Bank (600), which authorizes the transaction. In this embodiment, Stripe (300) and Processor (400)/Card Network (500) function together as a payment processor. In another embodiment, this step is performed without any communication to the Processor (400)/Card Network (500). Instead, Stripe (300) performs its own authorization or validation of the payment information using heuristic means, such as by checking the Bank Identification Number (BIN), also referred to as the Issuer Identification Number (IIN), against a database of known valid BINs that is on file with Stripe (300). (The BIN is a part of the bank card number, namely the first six digits.) In yet another embodiment, this step is not performed at all since the authorization or validation is not necessary for the next step 4 to succeed. That is, it is acceptable to create a Single-use Token in step 4A that represents payment information which has not been validated in any way.

4. If authorized, Stripe (300) will generate and return a secure, Single-use Token (350) to the Customer’s Browser (210) that represents the customer’s payment information (220) but doesn’t leak any sensitive information. In the embodiment wherein step A3 is not performed, Stripe (300) performs this step without waiting to receive authorization from the Processor (400) or the Card Network (500). In this manner, the payment processor (here, Stripe (300)) creates the Token (350) from the payment information sent by the client-side application, wherein the Token (350) functions as a proxy for the payment information (220).

5. The Payment Form (110) is submitted to Merchant’s Servers (120), including the Single-use Token (350). More specifically, the payment processor sends the Token (350) to the client-side application, which, in turn, sends the Token (350) to the server-side application for use by the server-side application in conducting the transaction.

6. The Merchant (100) uses the Single-use Token (350) to submit a charge request to Stripe (or to create a Customer object for later use). In this step, Stripe (300) submits a request to authorize the charge to the Processor (400) or directly to the Card Network (500). This authorization specifies the actual amount to charge the credit card. If an authorization was already done in step 3A for the correct amount, this authorization request can be skipped. This may be a one-time payment for a merchant item, or it may involve registering the payment information with the merchant site for subsequent use in making a payment for a merchant item (so-called “card on file” scenario). Using the process described in steps 1-6, the payment information can be used by the server-side application via the Token (350) without the server-side application being exposed to the payment information.

7. Stripe (300) settles the charge on behalf of the Merchant (100) with the Processor (400) or directly with the Card Network (500).

8. The Card Network (500) causes the funds to be paid by the Card Issuing Bank (600) to Stripe (300) or to Stripe’s Acquiring Bank (700).

9. Stripe (300) causes the settled funds to be sent to the Service Provider (100) (or to the Merchant’s Bank (800)), net of any applicable fees.

10A. The Card Issuing Bank (600) collects the paid funds from the Customer (200).

In some embodiments, the customer 200 and merchant 100 may access the rest of the platform of FIG. 1 with a user or computing device that may be mobile computing devices, such as a smartphone, tablet computer, smartwatch, etc., as well computer systems, such as a desktop computer system, laptop computer system, server computer systems, etc. The platform may also be one or more computing devices, such as one or more server computer systems, desktop computer systems, etc.

The platform of FIG. 1 including merchant user devices, customer user devices 130, and devices of the authorization/card networks may be coupled to a network and communicate with one another using any of the standard protocols for the exchange of information, including secure communication protocols. In some embodiments, one or more of the devices on the platform and devices of the authorization/card networks may run on one Local Area Network (LAN) and may be incorporated into the same physical or logical system, or different physical or logical systems or, alternatively, may reside on different LANs, wide area networks, cellular telephone networks, etc. that may be coupled together via the Internet but separated by firewalls, routers, and/or other network devices. In some embodiments, platform may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

### A Machine Learning Framework

In one embodiment, a machine learning (ML) framework that enables the building and running of predictive models is disclosed. These predictive models use a set of inputs that are referred to herein as features. A feature is about an entity about which a prediction is being made.

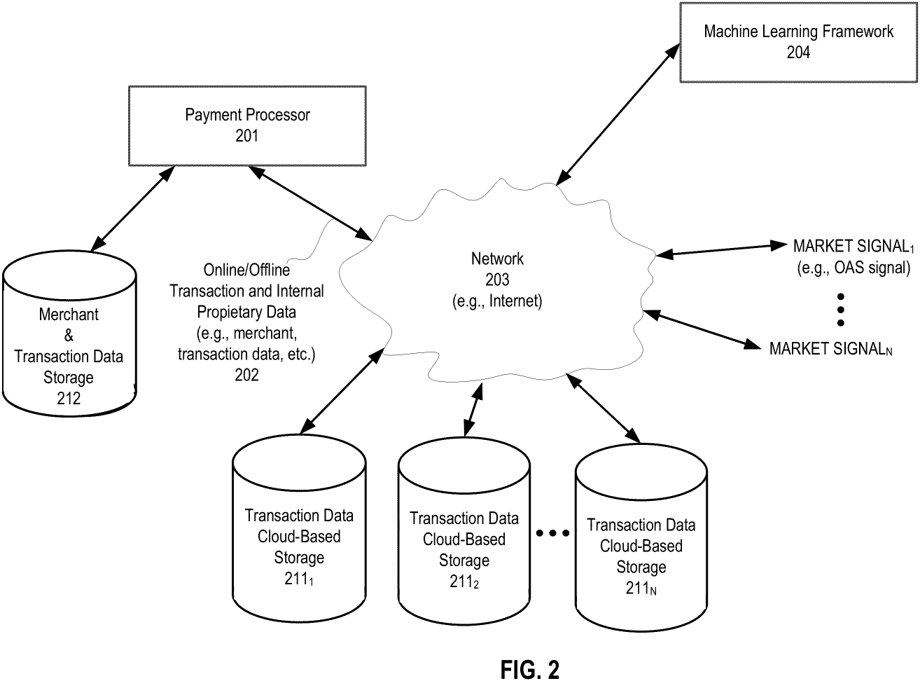

FIG. 2 is a bock diagram of a networked arrangement for a machine learning (ML) framework to access data from one or both of on-line and off-line storage. Referring to FIG. 2, payment processor 201 performs payment processing operations, such as, for example, those described above. As part of performing payment processing operations, an on-line data storage 210, which may include transaction data related to transactions that are processed, merchant data, etc. After a predetermined amount of time, payment processor 201 transfer transaction data related to transactions that are processed to one or more cloud-based storage locations, referred to herein as transaction data cloud-based storage 211₁-211_{N} or other off-line storage. In one embodiment, the transaction data is sent via network 203 (e.g., the Internet, etc.) for storage in one or more of transaction data cloud-based storage 211₁-211_{N}.

ML framework 204 accesses one or both of on-line transaction data from on-line storage 210 of payment processor 201 and off-line transaction data that is stored in transaction data cloud-based storage 211₁-211_{N} to build features that enable a payment processor or other institutions (e.g., bank, merchant, etc.) to collect and summarize information about past charges (e.g., fraudulent and genuine) and train algorithms to identify patterns of fraud and authenticity, which may include transaction data related to transactions that are processed, merchant data, data from API request, as well as other data. The trained algorithm is referred to herein as a model. In this case, many types of events are used to collect high-quality information about charges. For purposes herein, these are referred to as charge features. The better the charge features, the better chance of producing a high-quality model.

In one embodiment, a framework includes a library for producing feature definitions, as well as compiling those feature definitions to different platforms. In one embodiment, these feature definitions are event-based, declarative, and powerful enough to express existing features as well as features which were previously impossible.

In one embodiment, features are defined in a single place and potentially shareable between applications. In this case, users don’t need to worry about where historical data needed for features will be stored, or run their own infrastructure to compute features in real-time.

In one embodiment, the ML framework 204 is part of the payment processor 201 and may be implemented with one or more systems and/or devices of the payment processor (e.g., payment processing systems).

### An Example of the ML Framework

In one embodiment, the payment processor offers merchant cash advances (MCAs) in the form of flex loans and other loans to eligible merchants. If an offer is accepted, a merchant pays down the MCA/flex loan through a percentage of its future processing volumes. In one embodiment, the models employed by the ML framework predict the likelihood of a significant decrease in a merchant’s future processing volume. In one embodiment, this is accomplished by leveraging information derived from the merchant’s transaction activities to quantify its risk level. In one embodiment, the model is used in an underwriting process both for loan generation and loan financing terms (e.g., pricing). In one embodiment, a model score threshold is used as part of the eligibility criteria to determine whether a merchant will be eligible for a loan financing product (e.g., cash advance). Thus, the model produces scores that are used in underwriting process for both loan generation and loan financing terms (e.g., pricing).

In one embodiment, the ML framework follows the framework of General Additive Models (GAMs). In one embodiment, the model implements GA^2M with a constrained gradient boosting (GB) tree model (GBTM). For more information on GA^2M, see Lou et al., Accurate Intelligible Models with Pairwise Interactions, ACM 978-1-4503-7, 2013.

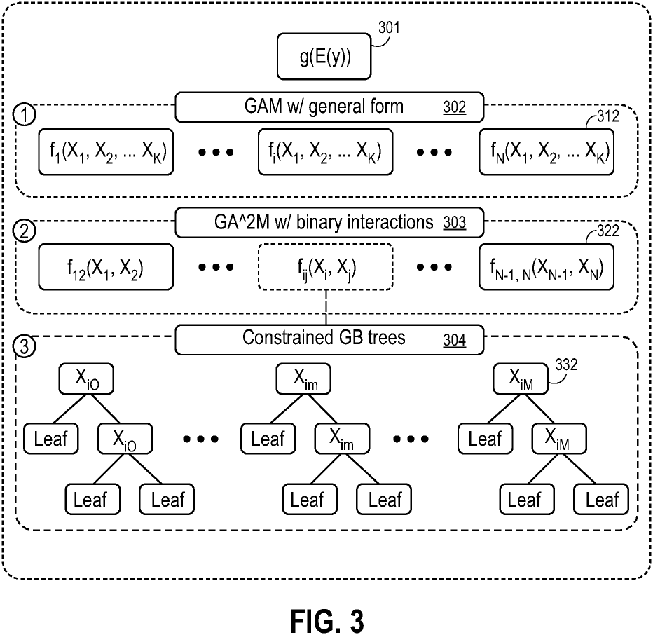

FIG. 3 is a representation of the GAM used in one embodiment of the ML framework. The most general function form 302 of a GAM is g(E(y)) 301 where

$$g \left(E \left(y\right)\right) = {\sum }_{i = 1}^{N} {f}_{i} \left({x}_{1} , {x}_{2} , {x}_{3} … {x}_{K}\right)$$

with N functions {f_{i=1,2,..,N}} and K features {x_{k=1,2,..,K}}. Each function characterizes the interactive relationship among K features.

In GA^2M, the interactions are limited at two dimensions, i.e., binary interactions 303 only.

$$g \left(E \left(y\right)\right) = \sum {f}_{i j} \left({x}_{i} , {x}_{j}\right)$$

Each interaction function/term can be visualized through a heatmap in GA^2M.

In one embodiment, GA^2M is implemented with GBTM with constrained GB tress 304. Examples of generic trees 332 are shown in FIG. 3. A GBTM is a GAM at its core: it adds together individual leafvalues from each tree and makes predictions based on the ensembled scores. In one embodiment, the model uses scores calibrated to (simulated) loss rates. In one embodiment, the model uses direct python railyard scoring to produce the score and batch scores each merchant every day. In one embodiment, each function/term fᵢⱼ(xᵢ, xⱼ) in GA^2M is constructed as the sum of the leaf values from a group of binary shallow trees (332) through a gradient boosting tree model (GBTM).

$${f}_{i j} \left({x}_{i} , {x}_{j}\right) = {\sum }_{m = 1}^{{M}_{i j}} T r e {e}_{i j , m} \left({x}_{i} , {x}_{j}\right)$$

In this way, the constrained GA2M model framework implemented with a constrained gradient boosting (GB) tree model (GBTM) produces predictions, with clear interpretability and consistent with business intuitions, with respect to cash flow based on the inputs using an ML model in order to determine whether to give a loan to a merchant.

In a heavily regulated environment subject to federal regulations such as the Equal Credit Opportunity Act and Fair Credit Reporting Act as well as different state codes, the use of models are scrutinized by regulators, mainly the Fed and OCC in the US. The biggest challenge is that regulators have only provided high level comments on using machine learning models in Banking but no specific guidance on best practices. For example, Fed SR 11-7 points out “[m]odel risk increases with greater model complexity, higher uncertainty about inputs and assumptions, broader extent of use, and larger potential impact.” OCC also comments in its Spring 2019 Semiannual Risk Perspective: “[n]ew technology and systems for evaluating and determining creditworthiness, such as machine learning, may add complexity while limiting transparency. Bank management should be able toexplain and defend underwriting and modeling decisions.” Therefore, the underwriting models are required to have clear interpretability and be consistent with business intuitions to avoid regulatory risk.

There are two levels of interpretability associated with the predictive model described herein.

1. The model can be explained by model-agnostic methods such as partial dependence plots (PDP), local surrogates (LIME), and SHAP values. These methods are data dependent, i.e., they need background data to approximate the distributions of features. For example, when a PDP is made to visualize the interactions of two features, assumptions need to be made on the distributions of all other features.

2. The model itself is interpretable. For example, the components of f = x₁x₂ + x₁x₃ + x₂x₃ can be examined and the interactions of any two features can be understood without the need to assume the distributions of other features. As discussed above, each interaction function/term can be examined through a heatmap in GA^2M. That is, each interaction function/term can be summarized into binary on x-axis and y-axis like a heat map. Since each binary interaction function is independent of the others, the model itself is interpretable. In one embodiment, the model is interpretable with or without background data.

Thus, in one embodiment, the model is an interpretable machine learning model. In such a case, the model is interpretable in that one can look at the model and see how it behaves and if given background data, one can see how it behaves. This characteristic enables to review the model operation and determine if meets regulations.

In one embodiment, monotonicity constraints are used to ensure there is an intuitive relationship between risk drivers and target. In one embodiment, both the business and regulators expect risk drivers to have an intuitive relationship with the target. For example, when churn rate increases, the default rate is expected to increase as well. Monotonicity constraints can turn difficult-to-interpret nonlinear, nonmonotonic models into interpretable, nonlinear, monotonic models.

In one embodiment, to enforce monotonicity constraints within the model, certain steps are taken. At each node, a split is penalized with a negative infinity gain if the monotonicity is violated in order to guarantee that monotonicity is enforced at node level. Also, within each tree, a monotonic decreasing relationship is assumed: the lower bound of the weight of a left child and the upper bound of the right child are the mean of their parent and uncle. This guarantees that monotonicity is enforced at tree level. Lastly, since GB is a GAM at its essence, the leaf values of its trees are added together and monotonicity is enforced at the model level. In some embodiments, the leaf values of multiple trees are added together to form decision tree ensembles.

In one embodiment, the model uses features based on one or more external market signals to calculate scores. In one embodiment, the model uses a feature based on an external Option Adjusted Spread (OAS) signal. The OAS is a spread between a computed OAS index of bonds in a given rating category and a spot treasury curve. The widened spread is a leading indicator of economic downturns and future defaults in non-investment grade bonds. The use of OAS calibration in the model enables the model to react to the changes in industry and market risk, which can be leveraged to inform policy and pricing adjustments in different economic conditions (e.g., COVID-19 pandemic, etc.).

In one embodiment, GBTM scores are calibrated with OAS through a simple logistic regression.

$$\begin{matrix}l n \left(\frac{N e w S c o r e}{1 - N e w S c o r e}\right) = \text{α+β} ⋅ l n \left(\frac{O r i g i n a l S c o r e}{1 - O r i g i n a l S c o r e}\right) + \text{γ} ⋅ \\ C a l i b r a t i o n I n d u s t r y O A S\end{matrix}$$

where the prediction target is the same as the GA^2M model and where example ranges of the estimation coefficients in some embodiments are:
Intercept α: -0.1 to -0.4
Log-odds of original score β : 0.6 to 1
OAS γ : 5-10
In one embodiment, a three-day moving average with a one-day lag is used for Industry OAS in calibration. The moving average smooths market volatilities and the one-day lag accommodates the limitation in data deliveryand production.

$$C a l i b r a t i o n I n d u s t r y O A {S}_{t} = \frac{1}{} \begin{matrix}t - 1 \\ \left({\sum }_{3} I n d u s t r y O A {S}_{i}\right) \\ t - 3\end{matrix}$$

This will provide a closed form solution for the new calibration score.

$$N e w S c o r e = \frac{1}{1 + e x p \left(- z\right)}$$

where

$$z = \text{α+β} ⋅ l n \left(\frac{O r i g i n a l S c o r e}{1 - O r i g i n a l S c o r e}\right) + \text{γ} ⋅ C a l i b r a t i o n I n d u s t r y O A S$$

### Example Flows

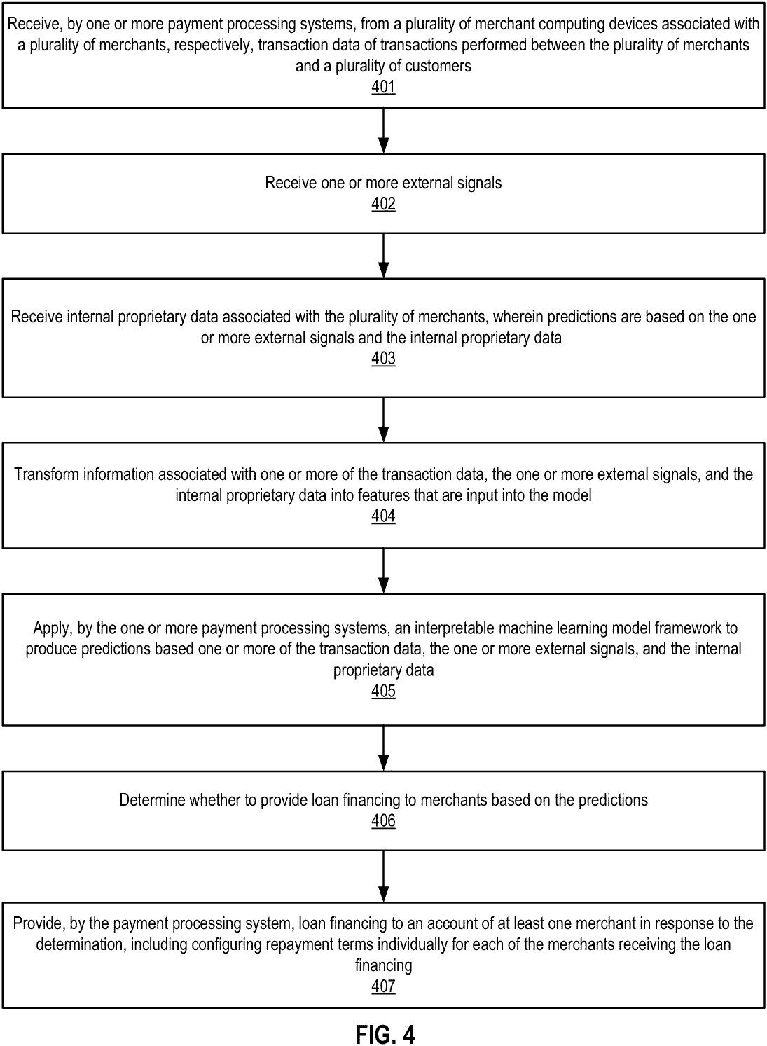

FIG. 4 illustrates one embodiment of a process flow for implementing loan financing process using the ML framework. In one embodiment, the processes are performed by processing logic that may comprise hardware (circuitry, dedicated logic, etc.), software (e.g., software running on a chip), firmware, or a combination of the three. In one embodiment, the process is performed by a payment processing system of a payment processor. An example of a payment processing system is described in more detail below. In the following example, the payment processor customer is a merchant. However, the techniques disclosed herein are not limited to use with a merchant, and may be any provider of a service or product.

Referring to FIG. 4, the process begins by processing logic receiving, from a plurality of merchant computing devices associated with a plurality of merchants, respectively, transaction data of transactions performed between the plurality of merchants and a plurality of customers (processing block 401).

In one embodiment, processing logic also receives one or more external signals (processing block 402) and receives internal proprietary data associated with the plurality of merchants (processing block 403). In one embodiment, the one or more external signals comprise a market signal. In one embodiment, the market signal comprise an option-adjusted spread (OAS) signal. In one embodiment, the market signal is obtained by setting up a communication channel (e.g., FTP communication channel) to obtain the market signal on a predetermined time interval from a remote location and receiving the market signal according to the predetermined time interval over the communication channel. In one embodiment, the internal proprietary data comprises dispute information associated with one or more of the plurality of merchants, information related to processing volumes, dispute rates, growth rates, churn rates, payment and charge information, negative balances, refunds, etc.

Processing logic transforms information associated with one or more of the transaction data, the one or more external signals, and the internal proprietary data into features that are input into the model (processing block 404). In some embodiments, six types of feature engineering and transformations are performed before training the model. In some embodiments, these may include one or more of the following: ratio, missing treatment, split, one-hot dummy on continuous feature, clip, and log. These are described as follows:
Ratio. Create the ratio of two features. For example, using the features of one month processing volume and twelve month processing volume, a ratio of one month to twelve month processing volume may be created:
Missing treatment. In some embodiments, though a model can be trained with missing values, missing treatments are specified to err on the conservative side. For example, if growth for one month year-over-year (growth_1mo_yoy) is null, then it’s set to 1; otherwise, it’s set to 0, while its value is assigned to a specific value [value] or set to the previous one month year-over-year growth rate
In some embodiments, a monotonic constraint is imposed, usually non-decreasing, on the missing dummy. The assigned [value] usually corresponds to a high event rate, e.g., zero for growth_1mo_yoy. Note that in some embodiments, the null dummy sometimes does not enter the final model, e.g., it is often automatically assigned a zero weight when using GB models.
Split. Certain features have a natural U-shape relationship with the event rate, e.g., one month growth year-over-year. In some embodiments, one or more U-shaped features are into two to impose monotonicity constraints during training. For example, if:
   growth_1mo_yoy < 1, growth_1mo_yoy_1 = growth_1mo_yoy; else growth_1mo_yoy_split_1 = 1, and
   if growth_1mo_yoy >= 1, growth_1mo_yoy_2 = growth_1mo_yoy; else growth_1mo_yoy_split_2 = 1
As shown above, in some embodiments, a non-increasing constraint is imposed on growth_1mo_yoy_1 and a non-decreasing constraint on growth_1mo_yoy_2. The latter constraint is also a conservative measure to limit the reward to COVID growth. This is not a requirement.
One-hot dummy on continuous feature. This is used when there is a potential structurebreak in the feature-target relationship at a certain value. For example, in some embodiments, a dummy indicator is applied at a zero refund ratio.
Clip. Assign values outside boundary to boundary values in order to account for outliers
Log. Apply natural log transformation with bias. For example, a log may be applied to a feature such as the twelve month processing volume (e.g., ln(volume_usd_12mo + 1).

Referring back to FIG. 4, once features have been generated, processing logic applies an interpretable machine learning (ML) model framework to produce predictions based one or more of the transaction data, the one or more external signals, and the internal proprietary data (processing block 405). In one embodiment, the predictions include a prediction that future processing volume of transaction indicative of future revenue for the merchant is going to change from processing volume indicated by the transaction data. In one embodiment, the prediction comprises a prediction of a decrease or an increase in the future processing volume of the merchant.

In one embodiment, the interpretable machine learning model framework comprises a constrained GA2M model framework implemented with a constrained gradient boosting (GB) tree model (GBTM) without tree pruning. In one embodiment, the model sums components (leafnodes) to make the predictions and uses monotonicity constraints to ensure an intuitive relationship exists between risk drivers and model prediction targets.

Based on the results of applying the interpretable ML model framework, processing logic determines whether to provide loan financing to merchants based on the predictions (processing block 406). In one embodiment, the loan financing relates to a cash advance or flex loan.

Processing logic provides loan financing to an account of at least one merchant in response to the determination, including configuring repayment terms individually for each of the merchants receiving the loan financing (processing block 407).

In one embodiment, the platform described above is augmented to allow customers (e.g., merchants, service providers, etc.) of a payment processor (e.g., Stripe) to receive an advance on their future payments, and then pay down this advance and its cost from a portion of each of their payments. Note that in another embodiment, the paydowns of the advance and its costs are done only using a subset (e.g., less than all) of the payments being processed for the customer.

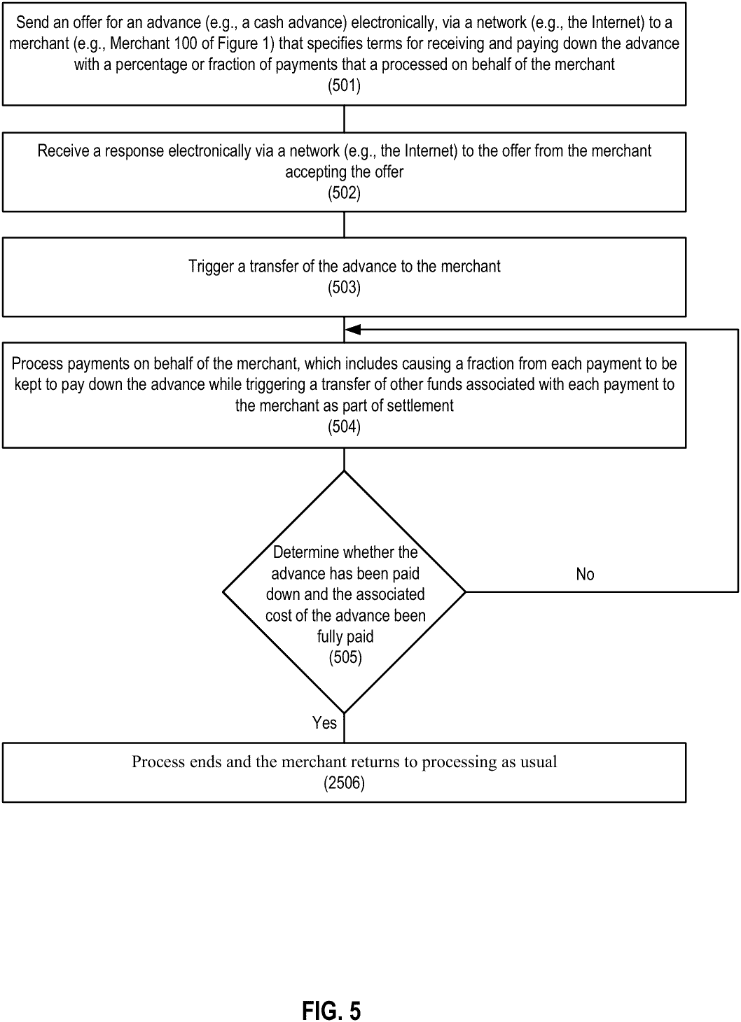

FIG. 5 illustrates one embodiment of a process flow for implementing an advance on future payments. In one embodiment, the processes are performed by processing logic that may comprise hardware (circuitry, dedicated logic, etc.), software (e.g., software running on a chip), firmware, or a combination of the three. In one embodiment, the process is performed by a payment processing system of a payment processor. An example of a payment processing system is described in more detail below. In the following example, the payment processor customer is a merchant. However, the techniques disclosed herein are not limited to use with a merchant, and may be any provider of a service or product.

Referring to FIG. 5, the process begins by processing logic sending an offer for an advance (e.g., a cash advance) electronically, via a network (e.g., the Internet), to a merchant (e.g., Merchant 100 of FIG. 1) that specifies the advance amount and terms for receiving and paying down the advance with a percentage or fraction of payments that are processed on behalf of the merchant by the payment processor (processing block 501). For example, the terms might specify that the cost of the advance is a number from 10-20% of the advance amount and that the withhold rate of the payments that are processed daily by the payment processing system is a percentage from 1-20%. These are only examples of numbers and others may be used. In one embodiment, this offer is sent by the payment processing system and its processing logic (e.g., Stripe 300 and Processor 400 of FIG. 1).

Subsequently, processing logic receives a response electronically, via a network (e.g., the Internet), to the offer from the merchant accepting the offer (processing block 502). In response to the acceptance, processing logic triggers a transfer of the advance to the merchant (processing block 503). This may be performed by the payment processor (e.g., Stripe 300 and Processor 400) sending a request for a bank transfer from its bank to the merchant’s bank (e.g., Merchant’s bank 800).

Thereafter, processing logic processes payments on behalf of the merchant, which includes causing a fraction from each payment to be kept to pay down the advance and the cost of the advance while triggering a transfer of other funds associated with each payment to the merchant as part of settlement (processing block 504).

Processing logic determines whether the advance has been paid down and whether the associated cost of the advance has been fully paid (processing block 505). If not, the process transitions to processing block 504 and the process continues until the advance has been paid down and the associated cost of the advance has been fully paid. If the advance has been paid down completely and the associated cost of the advance been fully paid, the process transitions to processing block 506 where the process ends and the merchant returns to processing as usual.

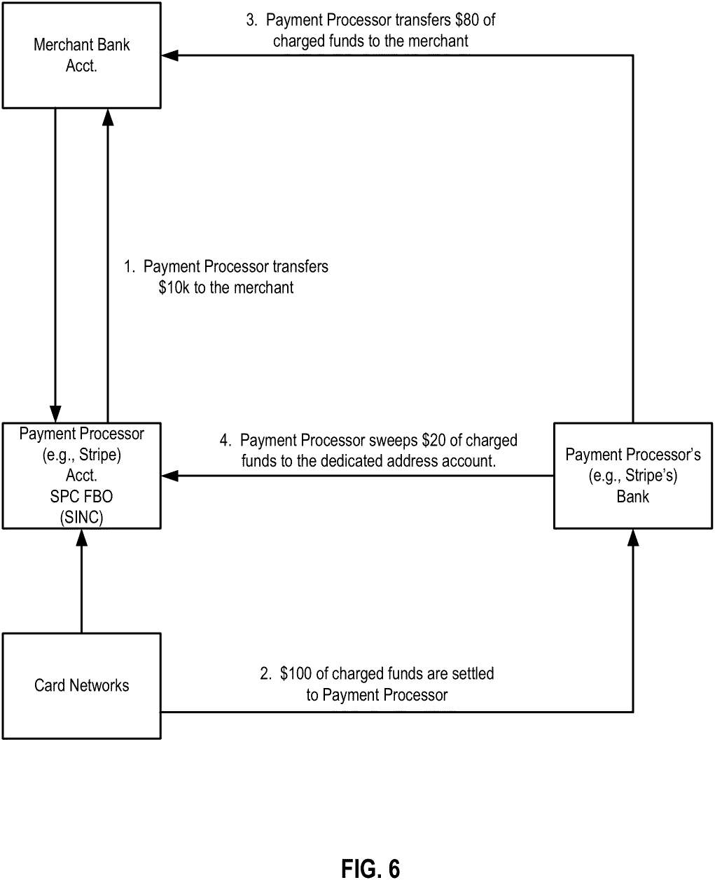

FIG. 6 illustrates an example of a process for handling the advances described herein in conjunction with a payment processing flow. In this case, payment processor offers a merchant $10 K using an electronic communication (e.g., a network request). The electronic communication included a notification or alert detailing the advance amount and terms depicting the cost of the advance (e.g., 20%) and the terms for paying down the advance (e.g., a fraction or percentage of 20% that is to be taken from each payment processed for paying down the advance and its cost). After receiving the offer notification for $10 K, the merchant accepts the offer. This may be done by using a graphical user interface (GUI) element (e.g., a button, link, etc.) that causes an electronic communication (e.g., a network response) to be sent accepting the offer, which is received by the payment processor.

Referring to FIG. 6, after the offer of the advance has been accepted, the payment processor (e.g., Stripe) transfers the advance amount (e.g., $10 K) to the merchant. Subsequently, the $100 of charge funds is settled to the payment processor on behalf of the merchant. The payment processor transfers $80 of the charged funds to the merchant and sweeps $20 (e.g., the 20% paydown fraction) of the charged funds to an advance account of the payment processor. In one embodiment, the advance account is SPC FBO (SINC).

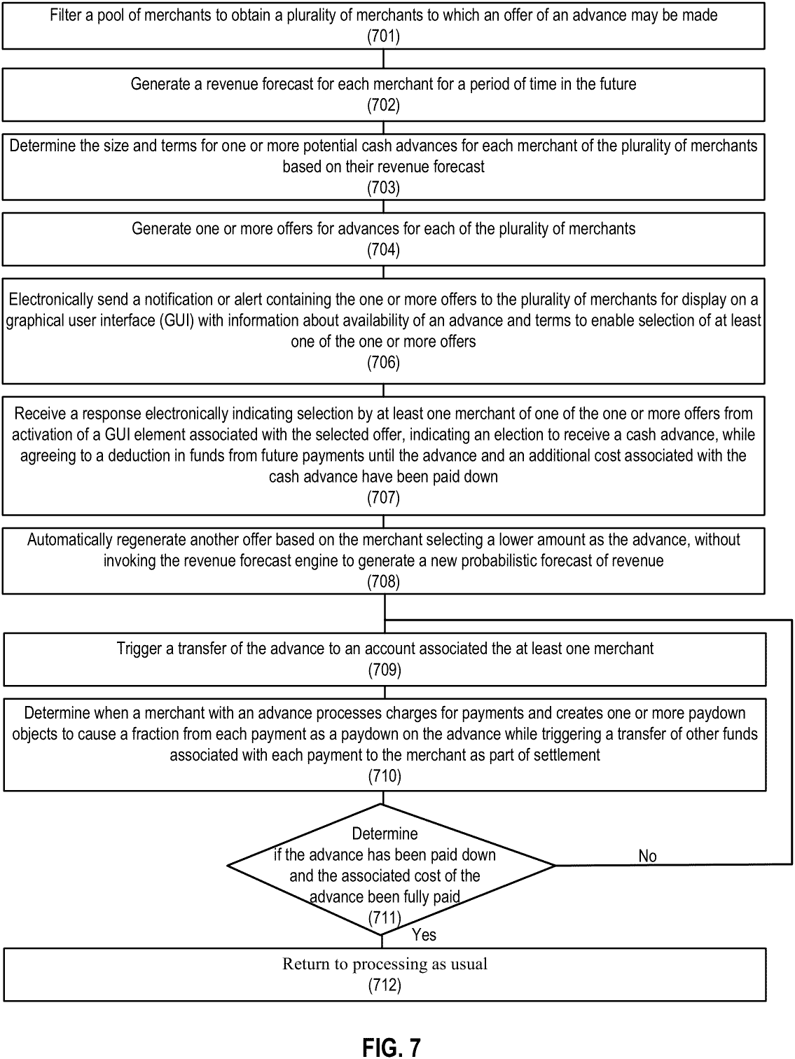

FIG. 7 is a more detailed flow diagram of one embodiment of a process for performing an advance that is paid down when processing transactions with a payment processing system. In one embodiment, the processes are performed by processing logic that may comprise hardware (circuitry, dedicated logic, etc.), software (e.g., software running on a chip), firmware, or a combination of the three. In one embodiment, the process is performed by a payment processing system of a payment processor. An example of a payment processing system is described in more detail below.

Referring to FIG. 7, the process begins by filtering a pool of merchants to obtain a plurality of merchants to which an offer of an advance may be made (processing block 701). In one embodiment, the pool of merchants comprises all the merchants for which the payment processor system is handling payment processing. The filtering may be used to select only merchants that have one or more of a predetermined level of revenue (e.g., $10,000), a diversity of product categories, an increase in sales over time (e.g., revenue growth for the 3rd month being at least 1.05 times the size of the first month), a predetermined amount of time associated with the payment processing system (e.g., at least 4 weeks, etc.), predetermined locations (e.g., only merchants in the US receive advances, etc.), etc. In one embodiment, this operation is not performed and all merchants are evaluated using the operations below.

In one embodiment, the payment processing system automatically sends a notification to the merchant to notify the merchant when they become eligible for a cash advance. The notification may take many forms including, but not limited to, an email notification, a text message notification, etc.

For the plurality of merchants that remain after filtering, processing logic generates a revenue forecast for each merchant for a period of time in the future (processing block 702). In one embodiment, the revenue forecast is a probabilistic revenue forecast generated with a revenue forecasting engine. In one embodiment, the revenue forecasting engine generates a plurality of time series revenue forecasts in parallel for the plurality of merchants. In one embodiment, this parallelism is accomplished using a distributed general-purpose cluster-computing framework (e.g., Apache Spark, etc.) that is able to receive and schedule the execution of revenue forecasting function in parallel on one or more clusters (e.g., parallel virtual machines). In this manner, the system is able to generate hundreds or even thousands of revenue forecasts for each merchant at the same time, thereby greatly reducing the amount of time necessary to perform the revenue forecasting. In one embodiment, the time series models used to generate the revenue forecasts for the merchants are trained in parallel.

In one embodiment, the period of time for the revenue forecast is predetermined. The period of time may be one year, eighteen months, two years, or any period of time into the future. In one embodiment, this period of time is programmable within the payment processing system.

Once a revenue forecast has been generated for each merchant, processing logic determines the size and terms for one or more potential cash advances for each merchant of the plurality of merchants based on their revenue forecast (processing block 703). In one embodiment, this determination is made using a pricing engine of the payment processing system. In one embodiment, one output of the pricing engine is a maximum advance amount for each merchant of the plurality of merchants and is generated as a result of determining the size and terms for one or more potential cash advances. In one embodiment, the pricing engine performs a search over every possible cash advance with terms deemed acceptable for that individual merchant. In one embodiment, the search is a grid search. Other types of searches or ways to generate offers may be used. An example of one such alternative is described in more detail below. In one embodiment, the pricing engine calculates a probabilistic rate of return associated with the probabilistic forecast of revenue assuming the terms. In other words, the pricing engine determines a rate of return that would be associated with one or more advance amounts in view of the probabilistic revenue forecast. In one embodiment, rates of return in the order of 20-30% are acceptable to the payment processing system for advance funds offers that are to be made.

After determining the size of one or more advances and their associated rates of return, processing logic automatically generates one or more offers for advances for each of the plurality of merchants (processing block 704).

In one embodiment, the multiple offers include the offer for each eligible merchant with the maximum advance amount. In one embodiment, if multiple offers exist for the maximum advance amount, the system selects the offer for which the IRR is closest to a predetermined target number (e.g., 20%, 25%, 30%, etc.).

Next, processing logic electronically sends a notification or alert containing the one or more offers to each of the plurality of merchants for display on a graphical user interface (GUI), where each of the offers includes information about the availability of an advance and its terms and enables selection of such an offer (processing block 706). In one embodiment, the notification comprises an electronic mail, text (e.g., SMS) or another message transferred over a network (e.g., the Internet). In one embodiment, the GUI is a merchant dashboard used by the merchant to track payment processing performed by the payment processing system.

In one embodiment, the notification indicates the availability of multiple, different cash advance amounts that may be selected by the merchant, along with the GUI element (e.g., a button, link, slider, drop down menu, other selectable indicia, etc.) to select each if the merchant so desires. In one embodiment, multiple cash advance offers are provided to merchants. Each of the offers has different terms. In one embodiment, these multiple offers are shown in a user interface (e.g., a dashboard). In one embodiment, for every cash advance that is extended, accurate estimates of the internal rate of return (IRR) are generated, the number of days it will take to repay the advance from the generated forecasts are determined. In one embodiment, the cash advance offers that are produced have reasonable advance amounts, i.e. no offers for oddly-specific amounts like $6,307.

In one embodiment, the system is able to automatically regenerate another offer based on the merchant selecting a lower amount as the advance with the same rate of return, without invoking the revenue forecast engine to generate a new probabilistic forecast of revenue or invoking the pricing engine (processing block 708). In one embodiment, the terms of the smaller cash advances, along with accurate estimates of the internal rate of return (IRR) and the number of days it will take to repay the advance, are derived from the offer with the maximum advance amount. In one embodiment, this is performed by the merchant’s client that is used to view the offer, instead of having to return to the payment processing system to generate these numbers. Given an offer with advance amount a, withhold rate w, premium rate p, it is possible to derive a new offer that has the same IRR and repayment schedule by dividing both the advance amount and the withhold rate by a common scalar factor k. In one embodiment, one or more commands executed by the system allow a merchant to accept the offer for any amount that is: divisible by a first predetermined number (e.g., $500 in one example); above a second predetermined number representing a minimum cash advance (e.g., $1,000 in the one example); and below third predetermined number representing a maximum cash advance (e.g., $25,000 in the one example). In one embodiment, the one or more commands create a new cash advance, prorating the advance amount and withhold rate accordingly. For example, if the merchant is eligible for up to $20,000 at a withhold rate of 7.5% and they accept $15,000, the system prorates the withhold rate to $15,000/$20,000 * 7.5% = 5.625%. In one embodiment, the withhold rate is rounded to one decimal place, i.e. in this case it would be 5.6%.

In one embodiment, the system generates and displays on a merchant dashboard three offers, where the first is for the full advance amount, the second is for 75% of the maximum advance amount, rounded up to the nearest $500 with the withhold rate prorated accordingly; and the third is for 50% of the maximum advance amount, rounded up to the nearest $500 with the withhold rate prorated accordingly. For example, if the maximum advance amount is $7,500 with a withhold rate of 12.5% and a premium rate of 10%, the system generates and enables display on the merchant dashboard the following offers: 1) $7,500 at a 12.5% withhold rate, with a premium of $750; 2) $5,500 at a 9.2% withhold rate, with a premium of $550; and 3) $4,000 at a 6.7% withhold rate, with a premium of $400.

In another embodiment, the merchant’s user interface includes a slider, or trackbar (e.g., a GUI element with which a user may set a value by moving an indicator) that a user may move between a minimum cash advance amount to a maximum cash advance amount, thereby enabling the user to select the specific cash advance amount that is desired (between the two endpoints). Alternatively, the user could click on a point on the slider to select the cash advance amount that is desired. In one embodiment, based on the advance amount selected by the user with the slider, the system rounds up the advance amount to the nearest predetermined dollar amount (e.g., $500) and prorates the withhold rate accordingly.

In response to the offer notification, processing logic subsequently receives a response electronically indicating selection by at least one merchant of one of the one or more offers from activation of a GUI element associated with the selected offer, indicating an election to receive a cash advance, while agreeing to a deduction in funds from future payments until the advance and an additional cost associated with the cash advance have been paid down (processing block 707). In one embodiment, this election is performed by selecting a graphical user interface (GUI) element (e.g., button, link, reply, etc.) in a dashboard used by the merchant to track the merchant’s payment processing that is being performed by the payment processor. Thus, the response indicates that the merchant has elected to receive the cash advance, agreeing to let the payment processor deduct funds from their future payments until the advance and an additional cost associated with the cash advance have been paid down.

In one embodiment, the payment processing system receives a response (e.g., message, etc.) indicating that the merchant is not interested in receiving an advance at this time but would like to receive a reminder in the future regarding the advance to determine whether to take the advance at that time.

In one embodiment, offers are time limited and may expired after a predetermined period of time (e.g., one week, one month, thirty days, etc.). In one embodiment, new offers are automatically regenerated. In one embodiment, this occurs if the offers have expired and the merchant still meets the criteria for receiving an offer of an advance. In another embodiment, new offers are generated in response to a merchant’s revenue exceeding their revenue forecast by a predetermined amount that would warrant a higher advance amount.

Optionally, in one embodiment, even after an offer has been accepted by a merchant, the payment processing system performs a final review to determine if an advance will be given to the merchant. In other words, the payment processing system revokes an advance after the advance offer has been accepted by the merchant but hasn’t been paid. The payment processing system may decline to give an advance at this stage for one or more of a number of reasons. For example, by the time the offer was accepted by the merchant, the merchant may have been identified as a service violator. Also, it’s possible that the revenue of the merchant has dropped substantially between the time of the offer and its acceptance, and the advance is revoked due to the revenue drop. In one embodiment, this review might be performed by one or more individuals working with the payment processing system.

Assuming the payment processing system is continuing with an advance and in response to receiving a response indicating an advance offer has been accepted, processing logic triggers a transfer of the advance to an account associated with the at least one merchant (processing block 709). In one embodiment, the transfer occurs from an account of the payment processor to the merchant’s bank account. In one embodiment, the triggering of the transfer of the advance to the account of the merchant is performed via Automated Clearing House (ACH) in response to generating and sending a request electronically to the payment processor’s back (e.g., Stripe/Acquiring bank 700). In one embodiment, simultaneously with the transfer, the payment processor creates a balance transaction for the amount of transfer. This has the effect of ensuring that cash advances do not have a net effect on the merchant’s balance.

Processing logic then determines when a merchant with an advance processes charges for payments and creates one or more paydown objects to cause a fraction from each payment as a paydown on the advance while triggering a transfer of other funds associated with each payment to the merchant as part of settlement (processing block 710). In one embodiment, the paydown object is generated with a balance transaction for the merchant to track settlement of their funds. In one embodiment, this occurs every time in response to the merchant processing a charge and invokes use of the payment processor. As a result of the accompanying balance transaction, the merchant funds are settled by the payment processor.

In one embodiment, the creation of the paydown object causes the processing logic to create a sweep instruction to perform a sweep to transfer the fraction representing the paydown amount, out of the card network settlement account, and into an advance account. In one embodiment, this advance account is the account used to provide the cash advance to the merchant. Thus, the processing logic determines when a merchant processes a charge and where every time a payment is made to the merchant, the processing logic marks an agreed-upon fraction from the payment as a “paydown” on the advance and provides the rest to the merchant. For example, in one embodiment, the processing logic transfers a first fraction (e.g., 20%) of the processed charge as a paydown on the advance, while transferring a second fraction of those funds (e.g., 80%) to the merchant. Note that percentages other than 20%/80% may be used. In one embodiment, paydowns are generated asynchronously outside of the charge flow used to process charges made by and settled with the merchant.

In one embodiment, once a paydown has been created, it is never returned to the merchant. Therefore, in one embodiment, if a charge is refunded after capture or charged back, the paydown remains.

In one embodiment, the paydown sweeps may be batched and executed in single book transfer to transfer the cumulative paydown for all the sweeps. This single book transfer may be scheduled to occur at predetermined intervals (e.g., hourly, daily, weekly, monthly, etc.) and those would batch all of the paydown sweeps for the period of time associated with the interval into one cumulative amount. In one embodiment, only funds that correspond to paydowns are bundled into a transfer. For example, in one embodiment, adjustments, returned funds for disputes won, fees paid, and other activity on the merchant’s account are not factored into the paydown sweeps. In one embodiment, sweeps are dated by the estimated arrival time of funds from card networks, not by the date of the paydown.

Subsequently, processing logic determines whether the advance has been paid down and the associated cost of the advance has been fully paid (processing block 711), thereby determining that a merchant has satisfied an obligation to paydown the advance amount. If not, the process continues until the advance has been paid down and the associated cost of the advance has been fully paid. In one embodiment, determining when the at least one merchant has satisfied an obligation to paydown the advance amount includes tracking one or more balances remaining to be paid down associated with each advance (e.g., cash advance balance and the cost balance associated with the advance, a combined advance and advance cost balance, etc.) and using the balance(s) associated with the advance account for the at least one merchant to determine whether the at least one merchant has satisfied the obligation to paydown the advance.

If processing logic determines whether the advance has been paid down and the associated cost of the advance has been fully paid, the process ends and the merchant returns to processing as usual (processing block 712).

Note in the case of a cash advance as part of a flex loan, if the amounts paid down do not equal the minimum payments, processing logic in the system may perform operations to obtain an amount of money equal to the difference between the amount owed as a minimum payment and the amount actually paid down. In one embodiment, the processing logic of the payment processor payment processor performs a transfer, via ACH, from the merchant’s bank account to transfer the amount necessary to cover the difference.

### Other Applications of the ML Framework

In one embodiment, the ML framework may be used to make other types of predictions or predictions in addition to those regarding future revenue or future processing volume. These other types of predictions may include regulatory or compliance predictions. For example, these predictions may indicate that a regulatory or compliance problem is likely to occur in the future. In one embodiment, the predictions may be based on one or more of transaction data, internal proprietary information, and external signals.

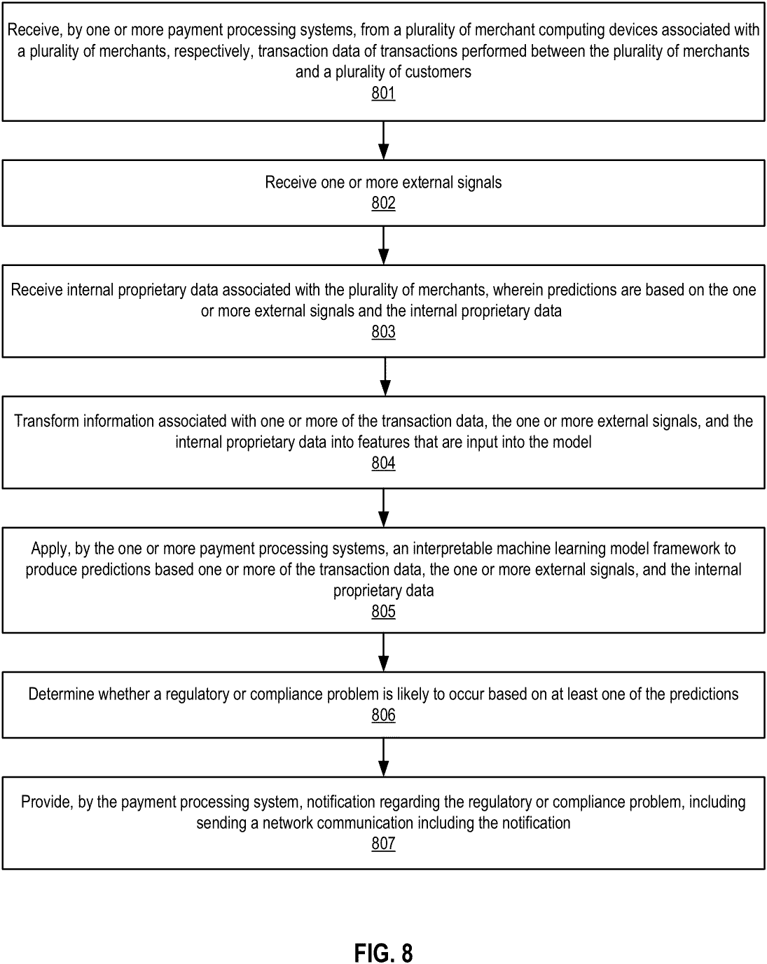

FIG. 8 illustrates one embodiment of a process flow for implementing a regulatory or compliance process using an ML framework. In one embodiment, the processes are performed by processing logic that may comprise hardware (circuitry, dedicated logic, etc.), software (e.g., software running on a chip), firmware, or a combination of the three. In one embodiment, the process is performed by a payment processing system of a payment processor. An example of a payment processing system is described in more detail below. In the following example, the payment processor customer is a merchant. However, the techniques disclosed herein are not limited to use with a merchant, and may be any provider of a service or product.

Referring to FIG. 8, the process begins by processing logic receiving, from a plurality of merchant computing devices associated with a plurality of merchants, respectively, transaction data of transactions performed between the plurality of merchants and a plurality of customers (processing block 801).

In one embodiment, processing logic also receives one or more external signals (processing block 802) and receives internal proprietary data associated with the plurality of merchants (processing block 803). In one embodiment, the one or more external signals comprise a market signal. In one embodiment, the market signal comprise an option-adjusted spread (OAS) signal. In one embodiment, the market signal is obtained by setting up a communication channel (e.g., FTP communication channel) to obtain the market signal on a predetermined time interval from a remote location and receiving the market signal according to the predetermined time interval over the communication channel. In one embodiment, the internal proprietary data comprises dispute information associated with one or more of the plurality of merchants.

Processing logic transforms information associated with one or more of the transaction data, the one or more external signals, and the internal proprietary data into features that are input into the model (processing block 804).

Once features have been generated, processing logic applies an interpretable machine learning (ML) model framework to produce predictions based one or more of the transaction data, the one or more external signals, and the internal proprietary data (processing block 805). In one embodiment, the predictions include a prediction for one of the merchants that a regulatory or compliance problem is likely to occur. In one embodiment, the interpretable machine learning model framework comprises a constrained GA2M model framework implemented with a constrained gradient boosting (GB) tree model (GBTM) without tree pruning.

Based on the generated predictions, processing logic determines whether a regulatory or compliance problem is likely to occur (processing block 806) and provides a notification regarding the regulatory or compliance problem (processing block 807). The notification may be sent as a network communication to the payment processor, merchant, bank, and/or regulator.

### An Example Payment Processing System

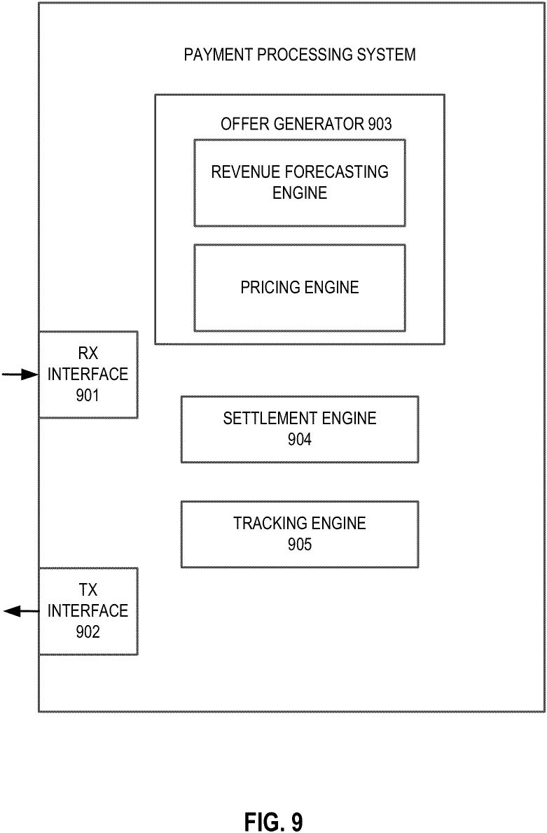

FIG. 9 is a block diagram of one embodiment of a payment processing system. The payment processing system comprises hardware (circuitry, dedicated logic, etc.), software (e.g., software running on a chip), firmware, or a combination of the three. While the payment processing system is shown as one system, in one embodiment, the payment processing system is implemented with more than one system (e.g., a plurality of processing devices, servers, computer systems, etc.).

Referring to FIG. 9, the payment processing system comprises a receive interface 901 and a transmit communication interface 902. Note that these may be the same interface. Receive interface 901 and transmit interface 902 communicate transaction information, including, but not limited to advance offer requests, acceptance/election responses and other information between the payment processing system and the merchants or other service providers.

In one embodiment, the payment processing system includes an advance funds offer generator 903 to receive merchant information regarding revenue and generate one or more offers for individual merchants. In one embodiment, offer generator 903 includes a revenue forecasting engine and a pricing engine that operate as described above

In one embodiment, the payment processing system includes settlement engine 904 for settling transactions including netted out transactions amounts between payment flows as described herein, including those associated with the fractions of charged funds used for paydowns of both advanced funds and the cost of the advanced funds.

In one embodiment, the payment processing system includes tracking engine 905 for tracking transactions, including those of the advanced funds transfers, paydowns and advanced funds accounts, to enable advanced funds to be given, paydowns to be made, and balances (e.g., advanced funds balance) to be tracked. In one embodiment, tracking engine 905 exchanges information with settlement engine 904 to enable settlement engine 904 to perform the netting of transaction amounts.

Note that the payment processing system includes other functional units and performs other well-known operations associated with payment processing.

### An Example Computer System

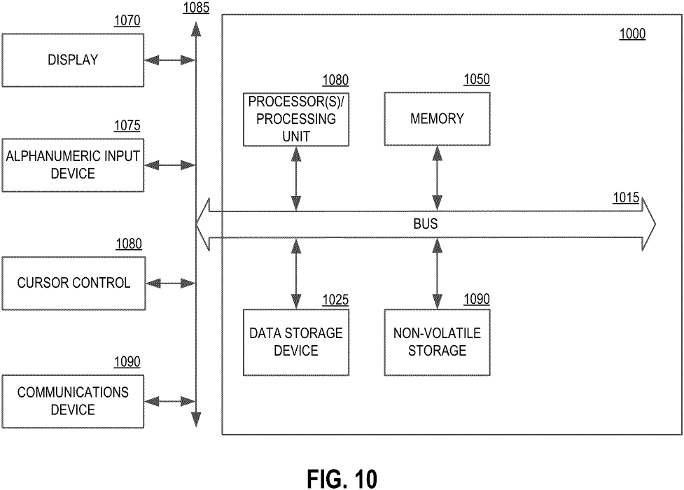

FIG. 10 is one embodiment of a computer system that may be used to support the systems and operations discussed herein. It will be apparent to those of ordinary skill in the art, however that other alternative systems of various system architectures may also be used.

The data processing system illustrated in FIG. 10 includes a bus or other internal communication means 1015 for communicating information, and a processor(s) 1010 coupled to the bus 1015 for processing information. The system further comprises a random-access memory (RAM) or other volatile storage device 1050 (referred to as memory), coupled to bus 1015 for storing information and instructions to be executed by processor 1010. Main memory 1050 also may be used for storing temporary variables or other intermediate information during execution of instructions by processor(s) 1010. The system also comprises a read only memory (ROM) and/or static storage device 1020 coupled to bus 1015 for storing static information and instructions for processor 1010, and a data storage device 1025 such as a magnetic disk or optical disk and its corresponding disk drive. Data storage device 1025 is coupled to bus 1015 for storing information and instructions.

The system may further be coupled to a display device 1070, such as a light emitting diode (LED) display or a liquid crystal display (LCD) coupled to bus 1015 through bus 1065 for displaying information to a computer user. An alphanumeric input device 1075, including alphanumeric and other keys, may also be coupled to bus 1015 through bus 1065 for communicating information and command selections to processor 1010. An additional user input device is cursor control device 1080, such as a touchpad, mouse, a trackball, stylus, or cursor direction keys coupled to bus 1015 through bus 1065 for communicating direction information and command selections to processor 1010, and for controlling cursor movement on display device 1070.

Another device, which may optionally be coupled to computer system 1000, is a communication device 1090 for accessing other nodes of a distributed system via a network. The communication device 1090 may include any of a number of commercially available networking peripheral devices such as those used for coupling to an Ethernet, token ring, Internet, or wide area network. The communication device 1090 may further be a null-modem connection, or any other mechanism that provides connectivity between the computer system 1000 and the outside world. Note that any or all of the components of this system illustrated in FIG. 10 and associated hardware may be used in various embodiments as discussed herein.

In one embodiment, processor(s) 1010 executes a revenue forecasting engine to generate a probabilistic forecast of processing volume (indicative of future revenue) for a plurality of merchants for a period of time in the future, executes a pricing engine to determine one or more potential cash advances, flex or other loans for each of the plurality of merchants; automatically generates one or more offers for advances for each of the plurality of merchants; electronically sends, via the network interface, a notification containing the one or more offers to the plurality of merchants for display on a graphical user interface (GUI) (e.g., a merchant dashboard used by the merchant to track payment processing performed by the payment processing system) with information about availability of an advance and terms to enable selection of at least one of the one or more offers; electronically receives, via the network interface, a response indicating selection by at least one merchant of one of the one or more offers from activation of a GUI element associated with the selected offer, indicating an election to receive a cash advance or other loan, while agreeing to a deduction in funds from future payments until the advance and an additional cost associated with the cash advance/loan have been paid down; triggers a transfer of the advance/loan to an account associated the at least one merchant; and determines when the at least one merchant processes charges for payments and creating one or more paydown objects to cause a fraction from each payment as a paydown on the advance while triggering a transfer of other funds associated with each payment to the merchant as part of settlement.

In one embodiment, processor(s) 1010 generate a plurality of revenue forecasts in parallel for each merchant of the plurality of merchants as part of executing the revenue forecasting engine. In one embodiment, processor(s) 1010 perform, as part of executing the pricing engine, a search over every possible cash advance/loan with terms deemed acceptable for each of the plurality of merchants and calculate, as part of executing the pricing engine, a probabilistic rate of return associated with the probabilistic forecast of revenue assuming the terms. In one embodiment, processor(s) 1010 create a sweep instruction to perform a sweep to transfer the fraction representing the paydown amount, out of the card network settlement account, and into an advance account and execute a settlement engine including hardware for settling transactions associated with each of the plurality of merchants. In one embodiment, the advance account is the account from which advances are paid to one or more merchants.

It will be appreciated by those of ordinary skill in the art that any configuration of the system may be used for various purposes according to the particular implementation. The control logic or software implementing the described embodiments can be stored in main memory 1050, mass storage device 1025, or other storage medium locally or remotely accessible to processor 1010.

It will be apparent to those of ordinary skill in the art that the system, method, and process described herein can be implemented as software stored in main memory 1050 or read only memory 1020 and executed by processor 1010. This control logic or software may also be resident on an article of manufacture comprising a computer readable medium having computer readable program code embodied therein and being readable by the mass storage device 1025 and for causing the processor 1010 to operate in accordance with the methods and teachings herein.

The embodiments discussed herein may also be embodied in a handheld or portable device containing a subset of the computer hardware components described above. For example, the handheld device may be configured to contain only the bus 1085, the processor 1010, and memory 1050 and/or 1025. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 1010, a data storage device 1025, a bus 1015, and memory 1050, and only rudimentary communications mechanisms, such as a small touch-screen that permits the user to communicate in a basic manner with the device. In general, the more special-purpose the device is, the fewer of the elements need be present for the device to function.

There is a number of example embodiments described herein.

Example 1 is a method comprising: receiving, by one or more payment processing systems, from a plurality of merchant computing devices associated with a plurality of merchants, respectively, transaction data of transactions performed between the plurality of merchants and a plurality of customers; applying, by the one or more payment processing systems, an interpretable machine learning model framework to produce predictions based at least on the transaction data; determining whether to provide loan financing to merchants based on the predictions; and providing, by the payment processing system, loan financing to an account of at least one merchant in response to the determination, including configuring repayment terms individually for each of the merchants receiving the loan financing.

Example 2 is the method of example 1 that may optionally include that the predictions include a prediction that future processing volume of transaction indicative of future revenue for the merchant is going to change from processing volume indicated by the transaction data.

Example 3 is the method of example 2 that may optionally include that the prediction comprises a prediction of a decrease or an increase in the future processing volume of the merchant.

Example 4 is the method of example 1 that may optionally include that the loan financing relates to a cash advance or flex loan.

Example 5 is the method of example 1 that may optionally include receiving one or more external signals; and receiving internal proprietary data associated with the plurality of merchants, wherein predictions are based on the one or more external signals and the internal proprietary data.

Example 6 is the method of example 5 that may optionally transforming information associated with the transaction data into features that are input into the model.

Example 7 is the method of example 5 that may optionally include that the internal proprietary data comprises dispute information associated with one or more of the plurality of merchants and the one or more external signals comprise a market signal.

Example 8 is the method of example 7 that may optionally include that the market signal comprise an option-adjusted spread (OAS) signal.

Example 9 is the method of example 8 that may optionally include setting up a communication channel to obtain the market signal on a predetermined time interval from a remote location; and receiving the market signal according to the predetermined time interval over the communication channel.

Example 10 is the method of example 1 that may optionally include that the interpretable machine learning model framework comprises a constrained GA^{2M} model framework implemented with a constrained gradient boosting (GB) tree model (GBTM) without tree pruning.

Example 11 is the method of example 1 that may optionally include that the model sums components to make the predictions and uses monotonicity constraints to ensure an intuitive relationship exists between risk drivers and target.

Example 12 is a payment processor system comprising: a memory to store instructions; and one or more processors coupled to the memory to execute the stored instructions to: receive from a plurality of merchant computing devices associated with a plurality of merchants, respectively, transaction data of transactions performed between the plurality of merchants and a plurality of customers; apply an interpretable machine learning model framework to produce predictions based at least on the transaction data; determine whether to provide loan financing to merchants based on the predictions; and provide loan financing to an account of at least one merchant in response to the determination, including configuring repayment terms individually for each of the merchants receiving the loan financing.

Example 13 is the system of example 12 that may optionally include that the predictions include a prediction that future processing volume of transaction indicative of future revenue for the merchant is going to change from processing volume indicated by the transaction data.

Example 14 is the system of example 12 that may optionally include that the one or more processors execute instructions to: receive one or more external signals; and receive internal proprietary data associated with the plurality of merchants, wherein predictions are based on the one or more external signals and the internal proprietary data.

Example 15 is the system of example 14 that may optionally include that the internal proprietary data comprises dispute information associated with one or more of the plurality of merchants and the one or more external signals comprise a market signal.

Example 16 is the system of example 15 that may optionally include that the market signal comprise an option-adjusted spread (OAS) signal received on communication channel on a predetermined time interval from a remote location.

Example 17 is the system of example 12 that may optionally include that the interpretable machine learning model framework comprises a constrained GA^{2M} model framework implemented with a constrained gradient boosting (GB) tree model (GBTM) without tree pruning.

Example 18 is the system of example 12 that may optionally include that the model sums components to make the predictions and uses monotonicity constraints to ensure an intuitive relationship exists between risk drivers and target.

Example 19 is one or more non-transitory computer readable storage media having instructions stored thereupon which, when executed by a system having at least a processor and a memory therein, cause the system to perform operations comprising: receiving, by one or more payment processing systems, from a plurality of merchant computing devices associated with a plurality of merchants, respectively, transaction data of transactions performed between the plurality of merchants and a plurality of customers; applying, by the one or more payment processing systems, an interpretable machine learning model framework to produce predictions based at least on the transaction data; determining whether to provide loan financing to merchants based on the predictions; and providing, by the payment processing system, loan financing to an account of at least one merchant in response to the determination, including configuring repayment terms individually for each of the merchants receiving the loan financing.

Example 20 is the one or more non-transitory computer readable storage media of example 19 that may optionally include that the predictions include a prediction that future processing volume of transaction indicative of future revenue for the merchant is going to change from processing volume indicated by the transaction data.

Example 21 is the one or more non-transitory computer readable storage media of example 19 that may optionally include that the operations further comprise: receiving one or more external signals; and receiving internal proprietary data associated with the plurality of merchants, wherein predictions are based on the one or more external signals and the internal proprietary data.

Example 22 is the one or more non-transitory computer readable storage media of example 21 that may optionally include that the one or more external signals comprise an option-adjusted spread (OAS) signal received on communication channel on a predetermined time interval from a remote location.

Example 23 is the one or more non-transitory computer readable storage media of example 19 that may optionally include thatthe interpretable machine learning model framework comprises a constrained GA^{2M} model framework implemented with a constrained gradient boosting (GB) tree model (GBTM) without tree pruning.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A method comprising:
receiving, by one or more payment processing systems, from a plurality of merchant computing devices associated with a plurality of merchants, respectively, transaction data of transactions performed between the plurality of merchants and a plurality of customers;
training, based on the transaction data, a machine learning model of an interpretable machine learning model framework to identify patterns of fraud and authenticity to produce predictions based on scores calibrated to loss rates, wherein the model operates based on a set of features and determines whether the predictions have regulatory risk, and further wherein the model is configured to have the set of features be visualizable to enable examination of whether model operation meets regulatory compliance with visualization of interactions of any two features of the set being understandable without need of other features in the set of features;
applying, by the one or more payment processing systems, the an interpretable machine learning model framework to produce an individual predictions for one or more merchants based on the scores calibrated to loss rates and at least on its transaction data;
determining whether to provide loan financing to the one or more merchants and loan financing terms associated with the loan financing based on the predictions; and
providing, by the payment processing system, loan financing to an account of at least one merchant in response to the determination, including configuring repayment terms individually for each of the merchants receiving the loan financing.

2. The method of claim 1 wherein the predictions include a prediction that future processing volume of transaction indicative of future revenue for the merchant is going to change from processing volume indicated by the transaction data.

3. The method of claim 2 wherein the prediction comprises a prediction of a decrease or an increase in the future processing volume of the merchant.

4. The method of claim 1 wherein the loan financing relates to a cash advance or flex loan.

5. The method of claim 1 further comprising:
receiving one or more external signals including receiving an external market signal over a network communication channel;
receiving internal proprietary data associated with the plurality of merchants, wherein predictions are based on the one or more external signals and the internal proprietary data, wherein the model uses features based on the one or more market signals and the internal proprietary data to calculate the scores and produce the predictions.

6. The method of claim 5 further comprising transforming information associated with the transaction data into features that are input into the model.

7. The method of claim 5 wherein the internal proprietary data comprises dispute information associated with one or more of the plurality of merchants and the one or more external signals comprise the external market signal.

8. The method of claim 7 wherein the market signal comprise an option-adjusted spread (OAS) signal.

9. The method of claim 8 further comprising:
setting up a communication channel to obtain the market signal on a predetermined time interval from a remote location; and
receiving the market signal according to the predetermined time interval over the communication channel.

10. The method of claim 1 wherein the interpretable machine learning model framework comprises a constrained GA^{2M} model framework implemented with a constrained gradient boosting (GB) tree model (GBTM) without tree pruning.

11. The method of claim 1 wherein the model sums components to make the predictions and uses monotonicity constraints to ensure an intuitive relationship exists between risk drivers and target.

12. A payment processor system comprising:
a memory to store instructions; and
one or more processors coupled to the memory to execute the stored instructions to:
receive from a plurality of merchant computing devices associated with a plurality of merchants, respectively, transaction data of transactions performed between the plurality of merchants and a plurality of customers;
train, based on the transaction data, a machine learning model of an interpretable machine learning model framework to identify patterns of fraud and authenticity to produce predictions based on scores calibrated to loss rates, wherein the model operates based on a set of features and determines whether the predictions have regulatory risk, and further wherein the model is configured to have the set of features be visualizable to enable examination of whether model operation meets regulatory compliance with visualization of interactions of any two features of the set being understandable without need of other features in the set of features;
apply the interpretable machine learning model framework to produce an individual predictions for one or more merchants based on the scores calibrated to loss rates and at least on the its transaction data;
determine whether to provide loan financing to the one or more merchants and loan financing terms associated with the loan financing based on the predictions; and
provide loan financing to an account of at least one merchant in response to the determination, including configuring repayment terms individually for each of the merchants receiving the loan financing.

13. The system of claim 12 wherein the predictions include a prediction that future processing volume of transaction indicative of future revenue for the merchant is going to change from processing volume indicated by the transaction data.

14. The system of claim 12 wherein the one or more processors execute instructions to:
receive one or more external signals including receiving an external market signal over a network communication channel;
receive internal proprietary data associated with the plurality of merchants, wherein predictions are based on the one or more external signals and the internal proprietary data, wherein the model uses features based on the one or more market signals and the internal proprietary data to calculate the scores and produce the predictions.

15. The system of claim 14 wherein the internal proprietary data comprises dispute information associated with one or more of the plurality of merchants .

16. The system of claim 15 wherein the market signal comprise an option-adjusted spread (OAS) signal received on communication channel on a predetermined time interval from a remote location.

17. The system of claim 12 wherein the interpretable machine learning model framework comprises a constrained GA^{2M} model framework implemented with a constrained gradient boosting (GB) tree model (GBTM) without tree pruning.

18. The system of claim 12 wherein the model sums components to make the predictions and uses monotonicity constraints to ensure an intuitive relationship exists between risk drivers and target.

19. One or more non-transitory computer readable storage media having instructions stored thereupon which, when executed by a system having at least a processor and a memory therein, cause the system to perform operations comprising:
receiving, by one or more payment processing systems, from a plurality of merchant computing devices associated with a plurality of merchants, respectively, transaction data of transactions performed between the plurality of merchants and a plurality of customers;
training, based on the transaction data, a machine learning model of an interpretable machine learning model framework to identify patterns of fraud and authenticity to produce predictions based on scores calibrated to loss rates, wherein the model operates based on a set of features and determines whether the predictions have regulatory risk, and further wherein the model is configured to have the set of features be visualizable to enable examination of whether model operation meets regulatory compliance with visualization of interactions of any two features of the set being understandable without need of other features in the set of features;
applying, by the one or more payment processing systems, the an interpretable machine learning model framework to produce an individual predictions for one or more merchants based on the scores calibrated to loss rates and at least on its transaction data;
determining whether to provide loan financing to the one or more merchants and loan financing terms associated with the loan financing based on the predictions; and
providing, by the payment processing system, loan financing to an account of at least one merchant in response to the determination, including configuring repayment terms individually for each of the merchants receiving the loan financing.

20. The one or more non-transitory computer readable storage media of claim 19 wherein the predictions include a prediction that future processing volume of transaction indicative of future revenue for the merchant is going to change from processing volume indicated by the transaction data.

21. The one or more non-transitory computer readable storage media of claim 19 wherein the operations further comprise:
receiving one or more external signals including receiving an external market signal over a network communication channel;
receiving internal proprietary data associated with the plurality of merchants, wherein predictions are based on the one or more external signals and the internal proprietary data, wherein the model uses features based on the one or more market signals and the internal proprietary data to calculate the scores and produce the predictions.

22. The one or more non-transitory computer readable storage media of claim 21 wherein the one or more external signals comprise an option-adjusted spread (OAS) signal received on communication channel on a predetermined time interval from a remote location.

23. The one or more non-transitory computer readable storage media of claim 19 wherein the interpretable machine learning model framework comprises a constrained GA^{2M} model framework implemented with a constrained gradient boosting (GB) tree model (GBTM) without tree pruning.
